(19) United States
(12) Patent Application Publication
(10) Pub. No.: US 2014/0251169 A1
(43) Pub. Date: Sep. 11, 2014

(54) METHOD FOR ADJUSTING THE DISTANCES BETWEEN CYLINDERS OF AN INKING UNIT AND PRINTING MACHINE

(71) Applicant: Manfred Loddenkoetter, Ibbenbueren (DE)

(72) Inventor: Manfred Loddenkoetter, Ibbenbueren (DE)

(73) Assignee: WINDMOELLER & HOELSCHER KG, Lengerich (DE)

(21) Appl. No.: 14/350,641

(22) PCT Filed: Oct. 25, 2012
(86) PCT No.: PCT/EP2012/071161

§ 371 Date: Apr. 9, 2014

(30) Foreign Application Priority Data
Nov. 9, 2011 (DE) 10 2011 086 047.9

(51) Int. Cl. B41F 31/00

(52) U.S. Cl. CPC B41F 31/004
USPC 101/348; 101/483

(57) ABSTRACT

A method for adjusting the distances between cylinders of an inking unit limiting at least two cylinder gaps and in which the distances are adjusted based on measurements, which are gathered from the surface of at least one of the cylinders of the inking unit.

It is considered novel and inventive that information is used, which was gathered during the adjustment of the distance between the two cylinders limiting a first cylinder gap for adjusting the distance between the two cylinders limiting a second cylinder gap.

A printing machine is also described and claimed for executing the above-described method.

The invention relates to a method for adjusting the distances between cylinders of an inking unit and a printing machine.

Methods are known for adjusting the distances between cylinders of an inking unit and printing machines comprising suitable inking units for implementing this method.

For example, EP 1 249 346 B1 shows such a method and such a printing machine. According to the teaching of this publication an optic sensor or a camera analyzes a substrate to be printed, which has passed through the above-mentioned printing machine, while the settings of the cylinders participating in the printing process at each respective inking unit was being adjusted. The sensor or the camera records the light emitted at a certain spectral range and, based on measurements, it optimizes the relative positions of the cylinders participating in the printing process, which limit the cylinder gap. In this processes it is disadvantageous that during the adjustment here the generation of maculation can occur, because initially printing must occur at cylinder positions not yet optimized, in order to obtain measurements for the control of the relative positions of the cylinders.

Another method for adjusting the relative positions of the cylinders is known from the publication DE 102 11 870 A1. Here it is suggested to first mutually roll cylinders of an inking unit against each other in order to achieve inking the cylinders and then, at a state of mutual contacting, to set them into an extended idle state. During this idle period here a streak forms on the circumferential area of the respective cylinder by the ink drying.

The width of this streak, which is equivalent to its extension in the circumferential direction, represents a measure for the compression between the two participating cylinders. Accordingly, to the cited publication this width is measured perhaps with a camera, and the measurement serves as the basis for optimizing the compression. The publication DE 102 11 870 A1 relates to offset printing machines, in which ink and humidifying agents are guided over a plurality of different cylinders until these raw materials of the offset printing process reach the die plate cylinder and finally the substrate to be printed. Accordingly, in the publication DE 102 11 870 A1 it is also suggested to pivotally suspend a camera device in an inking unit such that after the pivoting of the camera device the circumferential areas of various cylinders of the printing mechanism can be examined.

The measuring method shown has proven unsuitable for various printing methods, among other things including relief printing. In this printing method, among other things, large imprecisions develop due to the relatively thick flexible layers on the surfaces of some cylinders during the adjustment of the distance between the cylinders.

Accordingly, the objective of the present invention is to provide a method for adjusting the distances of cylinders participating in the printing process, which corrects this disadvantage.

The objective is attained in claims 1 and 13.

The application of measures according to the invention in connection with relief printing methods, such as in flexo-printing, is particularly advantageous. For the sake of completeness it shall be mentioned that the European Patent application EP 238 489 2 A1, still unpublished at the time the present publication was filed, as well as the also still unpublished PCT/EP2011/057417 show the measures of the preambles of claim 1 and 13. However, in the above-mentioned publications of prior art it is not taught to use information for adjusting the distance between the two cylinders limiting the second roller gap which were gathered during the adjustment of the distance between the two cylinders, which limit the first cylinder gap.

This can occur in various fashions:

Generally, the first roller gap is formed by the inking cylinder, which may be an anilox roll or a plain roll, and a die plate cylinder. In particular in die plate cylinders, which are used for relief printing, there are differences in elevation on the die plate cylinders and frequently here tolerances have to be accepted, which exceed the intended limits. It is therefore recommended to adjust this first roller gap, which frequently is also called inking gap, based on careful measurements.

How precisely this can occur is described in detail, among other things, in the two above-mentioned publications EP 238 489 2 A1 and PCT/EP2011/057417, with their disclosed content regarding this topic being mandatory for understanding the present publication and thus is included in the present publication by way of reference:

An optic sensor is pointed to the surface of one of the rollers, advantageously the inking roller. The light emitted by the roller surface can be measured via the sensor. When the cylinders forming the roller gap are adjusted in reference to each other and begin to contact each other this leads to a change of the measurements of the optic sensor. In particular, measurements such as the spectral intensity of the remitted light change due to contacting.

When by the above-described measures the relative distance has been determined that shall exist between the cylinders limiting the first cylinder gap in order to ensure an optimal ink transfer here conclusions can be drawn regarding the optimal relative position of the cylinders of the second cylinder gap.

This particularly applies when both cylinder gaps are limited at one of their sides by the very same cylinder and this cylinder shows the largest tolerances on its circumferential area among the participating cylinders. This is generally the case when the first roller gap is formed by an inking roller and a die plate cylinder and the second roller gap is limited by the same die plate cylinder and a counter pressure cylinder. In this case, the adjustment of the first roller gap yields reliable information regarding the tolerances and the embodiment of the die plate of the die plate cylinder.

These results can be used for the adjustment of the die plate cylinder contacting the impression cylinder or also a blanket cylinder. Here, at least one pre-setting can be performed similar to the contacting situation in the first roller gap. Of course, in this context different diameters of the inking cylinder and the impression cylinder or blanket cylinder also need to be considered for the adjustment.

The quality of the adjustment of the relative cylinder positions in reference to the second cylinder gap can then also be reviewed by way of measurements. It is possible to perform these measurements on different cylinder surfaces. However, it is beneficial to observe only one cylinder surface. Here, it has shown that the measurements can occur on a surface of one cylinder, which is either arranged upstream in reference to the two cylinder gaps or which limits the first cylinder gap towards the front, seen in the direction of transportation of the ink towards the substrate to be printed. This is the case, for example, in the above-mentioned inking roller. In flexo-printing machines plain rolls or anilox rolls are used for inking the die plate cylinders. As already stated and explained in detail in the two above-mentioned publications EP 238 489 2 A1 and PCT/EP2011/057417, this already leads to a contacting between cylinders for changing the ink layer on the ink transferring cylinder, even when no ink transfer has yet occurred. During a further enhancement of the contacting of course ink transfer occurs and a considerable weakening of the ink layer on the cylinder transferring ink. This can be measured very well.

Of course, an ink transfer can also be measured on the cylinder receiving the ink, such as a die plate cylinder. Advantageously the measuring of the ink layer occurs directly on the cylinder surface, i.e. without here any medium needing to be introduced, such as substrate to be printed or additional paper inserted in the cylinder gap for the purpose of absorbing printing ink.

In general it is advantageous for the first cylinder gap, where the information is gathered, upon which the adjustment or pre-adjustment of the second gap occurs, to be the cylinder gap and/or roller gap which is located most upstream in reference to the direction of ink transportation.

Here it shall be mentioned that the terms cylinder and roll(er) can be interchanged in the present publication and/or used equivalently.

In particular during run ups it will frequently occur that the cylinders rotate during the measurements. This means that the cylinders are made to contact each other, while they are rotating or while at least one of the cylinders is rotating. This means, among other things, that any excess ink transfer between the cylinders occurs during the rotation, which is equivalent to the situation during the printing operation, of course.

In additional or as an alternative to the rotation during the ink transfer here the cylinder, with the measurement occurring on its surface, can be rotating during said measurement. Here, different angular values are advantageous, about which the cylinder rotates.

With regards to the above-mentioned cylinder rotation it shall be mentioned, of course, that generally the rotation of both cylinders or rollers limiting a roller gap is advantageous.

Frequently it will be necessary to perform so-called run ups. During a run up the cylinders limiting a cylinder gap are rotating and the cylinders are made to approach each other. The approach can occur in steps. During one step the cylinder may perform several rotations. This may become necessary because even upon the cylinder contacting a measurable effect and/or a measurable change of the surface of the ink layer forms only after several rotations. Frequently the number of rotations will be different for various roller gaps. For example, the loss in ink can be quickly measured when the inking cylinder is made to contact a die plate cylinder. However, when the contacting situation in the printing gap is measured based on the ink loss on the surface of an upstream located inking roller, here frequently several rotations of the participating cylinders are necessary in order to verify the contact between the printing cylinder and the impression cylinder and/or between the printing cylinder and the substrate to be printed in the printing gap. This circumstance leads to the fact that the number of rotations of the participating cylinders in the inking gap should be lower than the one in the printing gap when measuring occurs on the inking roller or an upstream arranged roller.

For example, a run up may comprise for the cylinders, limiting the inking gap, gradually approaching each other with here during or after each step a number of rotations of the cylinders on which the measurements occur being waited for until said measurement actually occurs. After the inking gap has been adjusted, the rollers limiting it are mutually made to contact the next cylinder, frequently an impression cylinder. During the gradual approach (run up) the participating cylinders rotate by a second number of rotations M, until once more a measurement occurs. The second number M is here advantageously greater than the first number N.

In a flexo-printing machine the adjustment of the printing gap between the impression cylinder and the format cylinder can occur therefore such that, after the inking gap has been adjusted within the scope of the run up, and while the anilox roll and the format roller are made to contact the impression cylinder as a roller package, with here maintaining their optimized relative position:

After the expiration of a known lag of the measuring effect the above-mentioned sensor records the intensity of the light reflected on the anilox roll. Elevated block sections, now in addition to the anilox roll contact, also show a contact to the impression cylinder, lead on the anilox roll to a different light intensity than lower laying block sections, which only contact the anilox roll and are separated from the impression cylinder. Based on these light intensities a control device determines the sections of the block, which show contacting in the second roller gap (printing gap), and show sections not being in contact here. The contact information gathered here (contact image) allocates the control device to the previously determined elevation profile. By comparing the contact image with the elevation profile the control device can determine the additionally required approach of the format cylinder to the impression cylinder so that this roller gap also transfers ink completely and is kept from excessive squeezing.

During the comparison the contact image with the elevation profile the control device checks, which areas already show contacts in the elevation profile of the block with a roughly adjusted roller gap, and calculates the lower lying profile depths in the block based on the approach additionally required.

In general, the control device controls the processes occurring during the measurement, i.e. here all above-mentioned processing steps can run computer-controlled and the control device is adjusted such that it can execute them automatically. This applies for all methods described and claimed in this publication.

Additional exemplary embodiments of the invention are discernible from the graphic description and the claims.

The individual figures show:

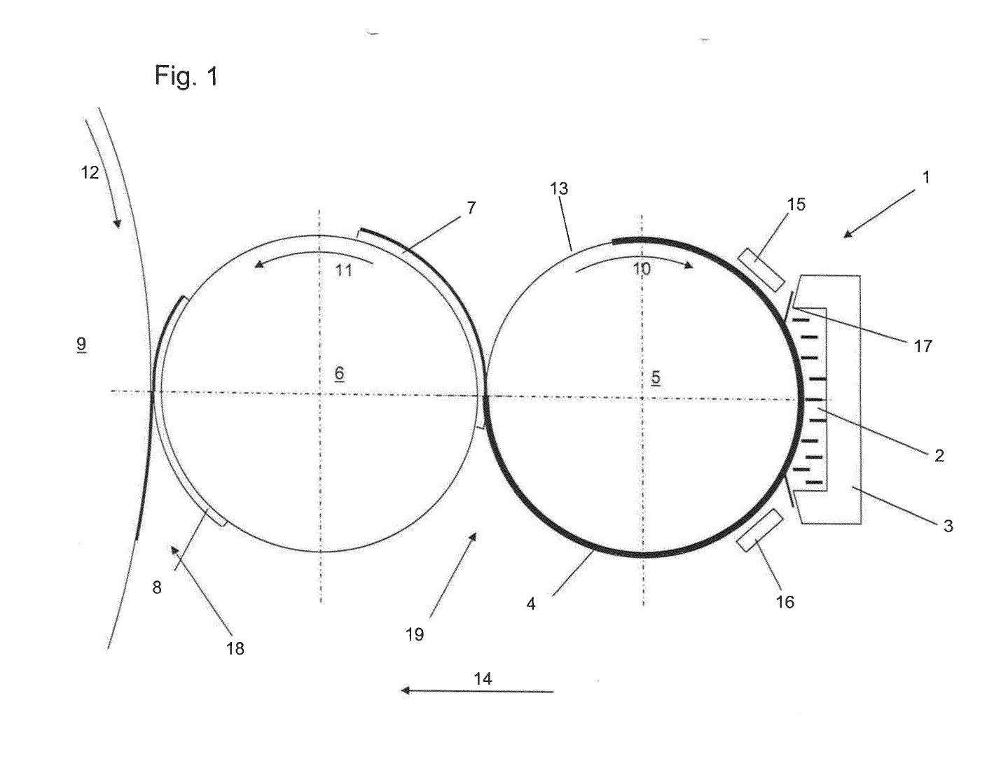

FIG. 1 a side view of the printing unit

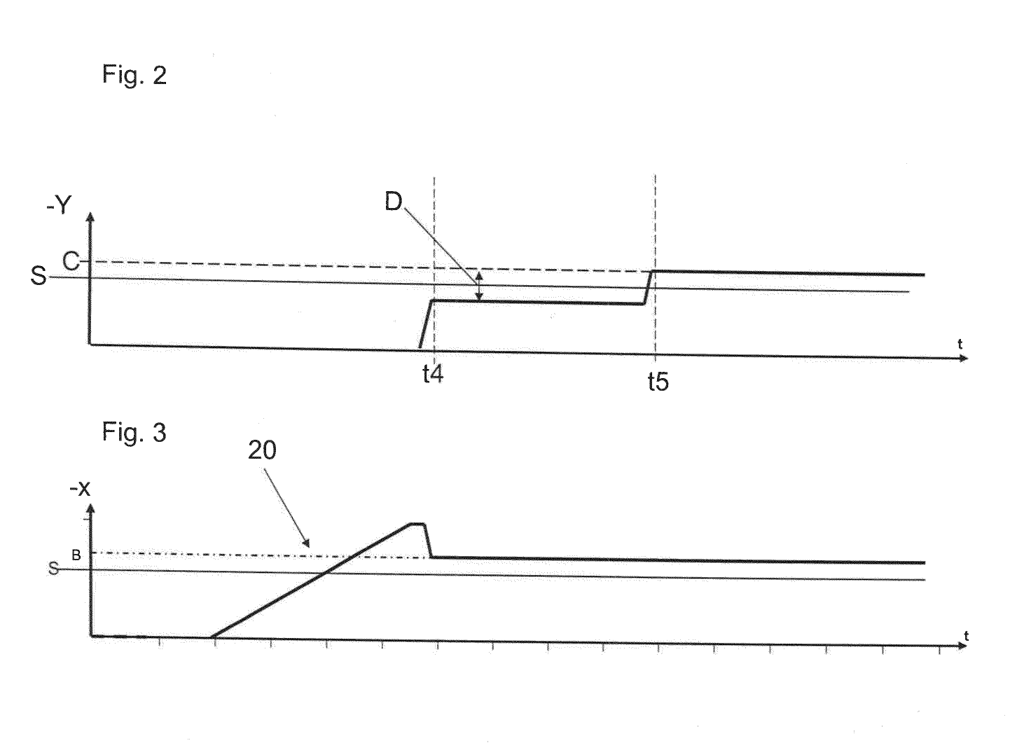

FIG. 2 The process of a first adjustment of the printing gap

FIG. 3 The process of a first adjustment of the inking gap

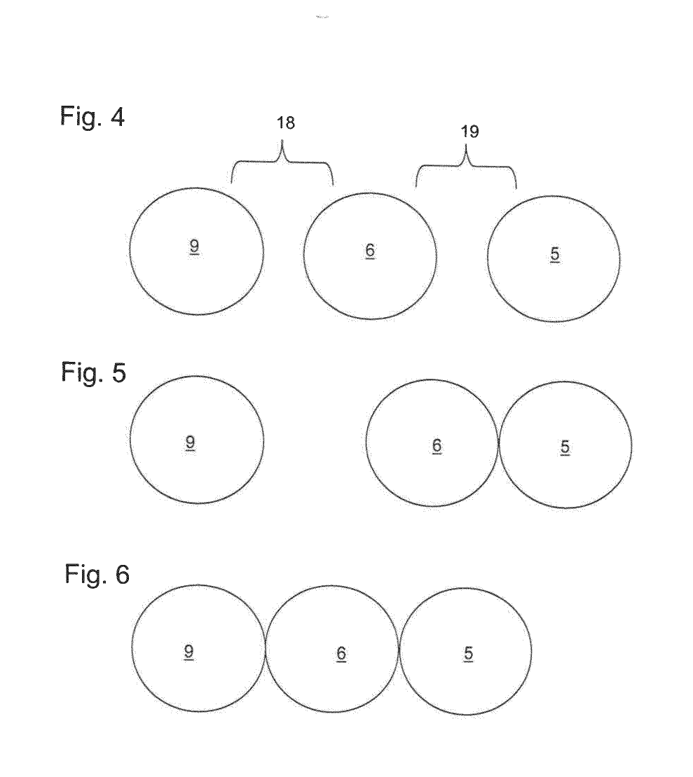

FIG. 4 A sketch of a first contacting situation of the cylinders of a flexo-printing unit participating in the printing process

FIG. 5 A sketch of a second contacting situation of the cylinders of a flexo-printing unit participating in the printing process

FIG. 6 A sketch of a third contacting situation of the cylinders of a flexo-printing unit participating in the printing process

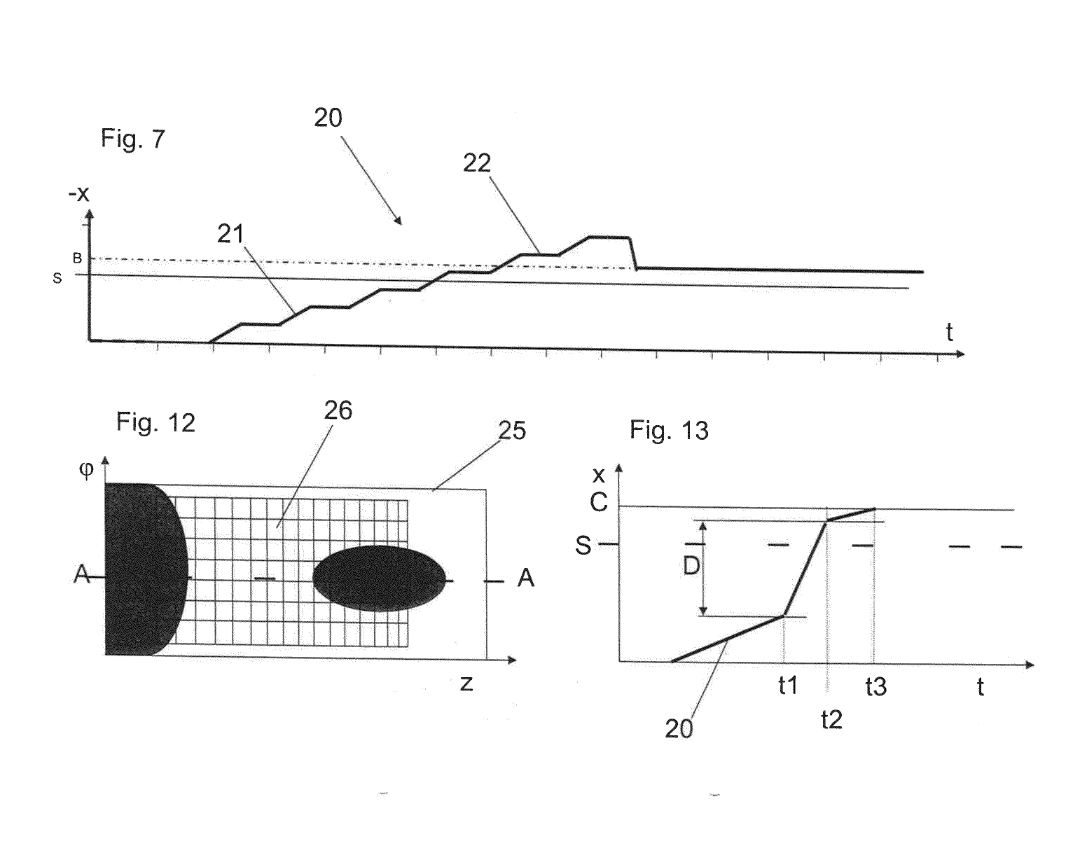

FIG. 7 The process of a second adjustment of an inking gap

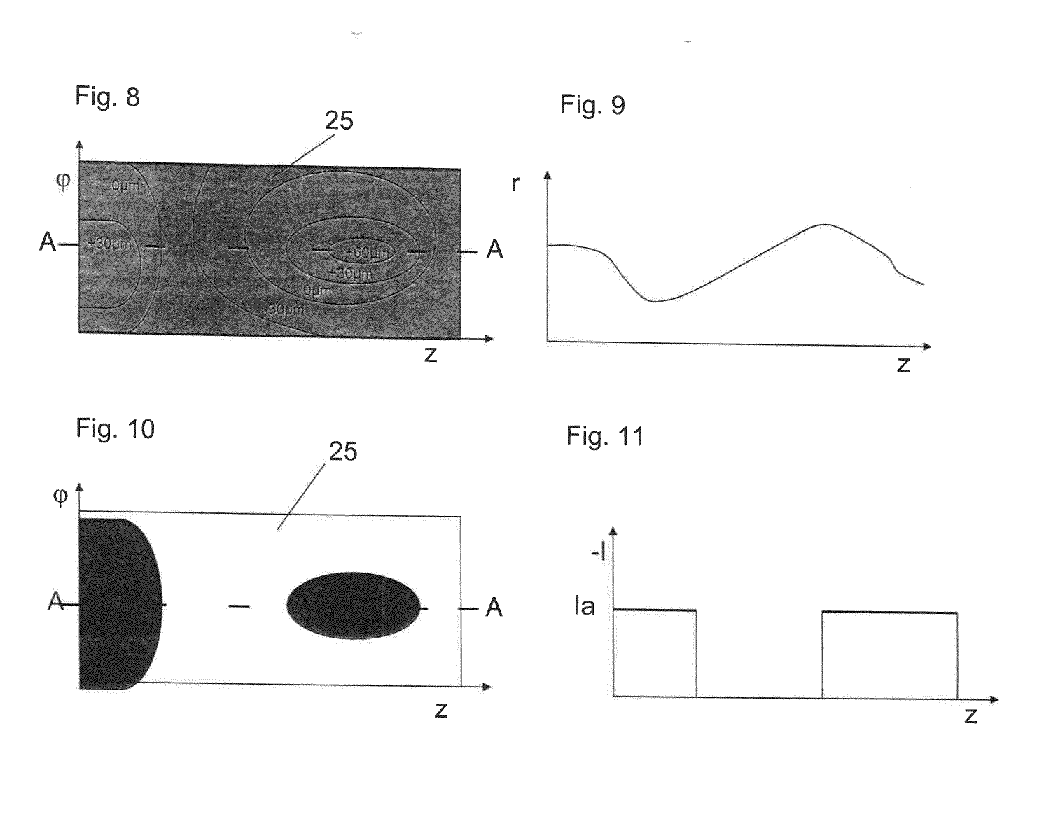

FIG. 8 A detailed elevation profile of a surface section 25 of the format cylinder

FIG. 9 The elevation profile along the line A-A of FIG. 8

FIG. 10 A simplified elevation profile of the surface section 25 of the format cylinder

FIG. 11 The progression of the intensity of the light emitted during a measurement along the line A-A

FIG. 12 The simplified elevation profile of FIG. 10, with sub-sections 26 of the surface section 25 being illustrated, here

FIG. 13 The process of a second adjustment of the printing gap

FIG. 1 shows a functional sketch of an inking unit 1. The ink 2, required for printing, is supplied to the inking unit 1 via the ink reservoir doctor 3. The ink reservoir doctor 3 contacts the anilox roll 5 and transfers the ink to the surface of the anilox roll 5, as discernible from the ink layer 4 on the surface of the anilox roll 5. The anilox roll 5 in turn contacts the format cylinder 6 and rotates in the direction of the arrow 10. It 5 also transfers ink from this ink layer 4 onto the block 7 of the format cylinder 6, while this 6 rotates in the direction of the arrow 11. The format cylinder 6 further comprises a second block 8. This second block 8 rolls straightly with the impression cylinder and transfers ink to the substrate to be printed, which rests on the surface of the impression cylinder 9, however it is not shown. The impression cylinder rotates in the direction of the arrow 12. It is also discernible from FIG. 1 that the block 8 during the rolling with the impression cylinder largely transfers the ink layer to the substrate to be printed. This also applies for the anilox roll 5, which shows a largely ink-free surface 13 after the rolling with the block 7. The detail of the surface of the anilox roll 5 referenced with the term “surface 13 largest free from ink” represents a surface area, which after passing the ink reservoir of the ink reservoir doctor 3 comes into contact with an area section of the format cylinder 6, thus with one of the two blocks 7 and 8. During this contacting an ink transfer may have already happened, however here merely a change of the surface of the ink layer 4 may have occurred. In both cases it is possible that a considerable change of the revision behavior of the ink layer and/or the respective surface of the anilox roll must be detected by the sensor 15 within the scope of the measurement. To this regard, the term “largely ink-free surface 13” therefore relates not to a mandatory condition that no ink layer is present on the respective area of the anilox roll.

The ink unit 1 causes overall a transportation of the ink 2 in the direction of ink transportation 14. The two optic sensors 15 and 16 shall be mentioned in particular. The optic sensor 15 can directly analyze the ink-free surface 13 of the anilox roll 5 when it 13 has moved along the direction indicated by the arrow 10 into the work area of the first optic sensor 15.

In this position the optic sensor 15 can also directly analyze the effect of the contacting between the anilox roll 5 and the format cylinder 6. As already mentioned in the introductory description, based on the change of the ink layer 4 the quality of the contacting between the anilox roll 5 and the format cylinder 6 can be determined by an optic measurement.

After the largely ink-less surface 13 of the anilox roll has passed the operating area of the first optic sensor 15 it also passes the doctor blade 17, with subsequently the largely inkless surface 13 being re-inked inside the ink reservoir doctor 3. After leaving the area of the ink reservoir doctor 3 the respective surface area of the anilox roll 5 can reach the operating area of the second optic sensor 16, which in the situation shown can analyze the quality of the ink coating of the respective surface area.

The FIGS. 4, 5, and 6 show the sequence in which the rollers of a flexo-printing unit 1 can be contacting each other in the fashion according to the invention.

FIG. 4 shows that the impression cylinder 9, the format cylinder 6, and the anilox roll 5 are separated from each other. Here, the brackets 18 and 19 refer to the inking gap 19 between the anilox roll 5 and the format cylinder 6 and the printing gap 18 between the format cylinder 6 and the impression cylinder 9.

In FIG. 5 the anilox roll and the format cylinder have already been made to contact each other. As already mentioned repeatedly, an optimized contacting position of these two cylinders 5 and 6 can be determined by a control and/or regulation method, in which a first optic sensor 15 monitors the change of the ink layer, developing on the surface of one of the two participating cylinders 5, 6, due to the contacting.

In FIG. 6 the three participating cylinders 5, 6, 9 of the flexo-printing unit 1 are already in the print position. As already mentioned, the objective of the present invention is to gather information, thus data, obtained during the determination of the optimized distance of the cylinders 5 and 6, for the determination of the optimized distance of the cylinders 6 and 9.

Here it must be considered, of course, that the cylinders might show different target diameters right from the start. For example, the central impression cylinder 9 of a central cylinder flexo-printing machine shows a much larger nominal diameter than the anilox roll, of course, which is mounted in an inking unit 1. Upon the anilox roll 5 contacting the format cylinder 6, within the scope of the examination of the ink layer 4 by the first optic sensor 15, information is gathered about the surface condition and the tolerances of the surface of the anilox roll 5, which can be used during the process of the format cylinder 6 contacting the impression cylinder 9. In this context it is particularly advantageous, based on this knowledge, to first perform a preliminary adjustment of the relative position between the format cylinder 6 and the impression cylinder 9.

It has shown that it is possible to examine the relative position of the format cylinder 6 and the impression cylinder 9 with a sensor as well, which examines the ink layer on a roller (such as the format cylinder 6) positioned upstream in reference to the impression cylinder in the direction of the ink transportation 14. Surprisingly, this also applies when the examination is performed on the surface of a cylinder already positioned upstream in reference to the format cylinder 6. Advantageously, this examination can therefore also be performed on the surface of the anilox roll, as indicated in FIG. 1. In this method it is therefore recommended to perform the contacting of the roller package comprising anilox roll 5 and format cylinder 6 jointly against the impression cylinder 9. Here, as already mentioned, first a pre-adjustment can be performed based on information gathered during the contacting of the anilox roll and the format cylinder 6.

Then it is possible to allow all three cylinders 5, 6, 9 continue rolling against each other and monitor the ink changes (primarily of the remitted light 1) on the surface of the anilox roll with a first optic sensor 15.

After some time, here measurable changes occur, which allow the discovery of the optimized contacting position C of the roller package comprising anilox roll 5 and format cylinder 6 in reference to the impression cylinder 9.

FIGS. 2 and 3 show the progression of such a contacting process for cylinders 5, 6, and 9 of a flexo-printing unit 1.

In order to adjust the inking gap 19 typically a run up 20 is executed. During the run up 20 the cylinders 5, 6, limiting the inking gap 19, rotate and the cylinders 5, 6 are made to approach each other. Such a run up 20 is shown in FIGS. 3 and 7. The relative distance of the two cylinders 5 and 6 is shown on the vertical axis marked with the control variable x.

This approach can occur in steps (as shown in FIG. 7) or continuously (as shown in FIG. 3). A sensor records the light remitted by the anilox roll at different roller distances x. Depending on the approach and the here occurring local contact of the cylinders the intensity I of the light varies, which is reflected by the anilox roll 5. During a gradual approach here one approaching step can be performed for each rotation of the format cylinder 6 so that a contact image can be generated from the sensor signals for each roller distance. From the contact images and the allocated roller distances here the roller distance required for the respective pressure can be determined at which the printing block completely contacts the anilox roll but no excessive squeezing occurs. The anilox roll 5 and the format cylinder 6 are adjusted in reference to each other to this distance, marked B in the figures. Here the distance frequently deviates from the target distance S, which results from the diameter data of the different cylinders 5, 6, 9 known to the control device as well as the blocks 7, 8 and the substrate to be printed.

During the analysis of the FIGS. 2, 3, and 7 it must be observed that the control variables are marked -x and -y, which here indicates that the relative distance between the respective cylinders 9, 6, and 5 reduces in the direction of the vertical axis.

As already mentioned, FIG. 7 shows a gradual run up 20 in which an approaching is performed between the cylinders 5, 6 in the sections 21 and in which no approaching occurs between the cylinders in the sections 22. Advantageously, in the sections 22 one or more roller rotations can be performed. At least one measurement can be recorded after or during at least one roller rotation. Due to the results of the run up 20 the cylinders 5, 6 can be made to contact each other, with the optimized distance B is adjusted, at which the ink transfer occurs, however the two rollers are not yet excessively squeezed. As already mentioned repeatedly, the publications EP 238 489 2 A1 and PCT/EP2011/057417 show this method in great detail, with their disclosed content regarding this topic being absolutely necessary for understanding the present publication, and which therefore is hereby included in the present publication by way of reference.

From the contact images and the allocated roller distances additionally an elevation profile 23, 24 of the format cylinder 6 can be determined. For this purpose, a control device checks at what positions a roller contact occurs with what distance -x. Such a detailed elevation profile is shown in FIG. 8. This figure shows a first detail 25 of the surface of a format cylinder 6. The various surface areas, showing different elevations, i.e. distances from the axis of the format cylinder, are allocated to different elevations in micrometers. The respective “progression of elevations” (which is marked with the radial coordinate r) along the line A-A is also shown in FIG. 9. The labeling of the coordinate axes in this publication (r, z, and f) is equivalent to the common use of cylinder coordinates in reference to the format cylinder 6.

FIG. 10 illustrates the same detail 25 of the surface of the format cylinder 6, with here the elevation profile 24 being shown less detailed. FIG. 11 shows the measurements a first optic sensor 15 can record from such an elevation profile along the line A-A. Along the vertical axis of the coordinate system shown in FIG. 11 the negative light intensity -I is shown of the light remitted by the surface of the anilox roll 5, resulting along the axial direction z. The reflection behavior of the ink coating 4 changes based on the contact between the anilox roll 5 and the format cylinder 6.

As already mentioned repeatedly, this can occur by a change of the surface of the ink layer and/or by an ink transfer and thus a loss of ink from the surface of the anilox roll 5. The first optic sensor 15 then records a reduced light intensity I in the area of the contact.

FIG. 12 shows that in the area of the detail 25 of the surface of the anilox roll S generally once more sub-sections 26 of the surface detail 25 are examined. These sub-sections 26 can then be allocated once more to light intensity values I based on measurements of the first optic sensor 15. Here, the rotation of the anilox roll can be recorded, among other things via a rotary generator.

Information regarding the elevation profile of the format cylinder 6 can be used for adjusting the second roller gap (printing gap) 18. This method is advantageous in reference to a run up 20 with the same analysis as in the inking gap 19 because the intensity I of the light reflected by the anilox roll 5 changes as a measuring effect with a time lag for a contact in the printing gap. This time-delayed run-up behavior occurs essentially only after a change of contact in the printing gap 18. After a change of contact in the inking gap 19 here a considerably faster occurring, measurable change of the light intensity I of the remitted light occurs than in the first optic sensor 15.

Based on the elevation profile of the format cylinder the roller distance between the format cylinder 6 and the impression cylinder 9 can be adjusted at least roughly such that some parts of the block 7, 8 come into contact with the impression cylinder and other parts do not.

This can occur as follows:

In a previous adjustment of the distance of the anilox roll 5 and the format cylinder 6 the control device has recorded and saved at least some of the measurements of the first optic sensor 15 together with the relative positions x of the respective rollers 5 and 6.

For example, the control device may save in a storage device certain values developing for light intervals at certain area sections 26 at a roller distance determined for the anilox roll 5 and the format cylinder 6.

Summarizing it can be said the pairs of values comprising data regarding the contact image and the relative cylinder position are saved.

If the control device now determines similar values during the approach of the roller package comprising the anilox roll 5 and the format cylinder 6, the control device can determine what additional adjustment value D is still necessary during the adjustment of the inking gap 19 in order to reach the optimized distance B.

FIG. 13 shows an example for such a process.

Until the point of time t1 the pair of rollers, comprising the anilox roll and the format cylinder, is made to contact the impression cylinder, and measurements are performed with the sensor 15 (run up 20) after a respective fixed number of rotations of the participating rollers, which of course may be different depending on their diameters. At the point of time t1 a measurement occurs, which detects the control device after a comparison with the measurements during the adjustment of the inking gap as being similar to the measurement (during the adjustment of the inking gap). Due to the fact that it is also stored in the control device what relative position was assumed by the anilox roll and the format cylinder 5 at the respective measurement the control device can determine by forming the difference with the final optimized contacting position B what additional contacting value D was still necessary to adjust the inking gap 19. The control device therefore changes the relative position of the format cylinder by this additional approaching value D in reference to the impression cylinder until the point of time t2.

At the point of time t2 another measurement is performed, which shows that another adjustment is required in order to achieve the optimized distance C. This C is reached at the point of time t3.

Frequently it will occur that the control device deducts a correction value E from the additional adjustment value D before it performs the adjustment by the additional adjustment value D. The correction value D can be obtained empirically and it should be considered that the surface features of the impression cylinder 9 are different from those of the anilox roll 5, of course, which is one of the reasons for a different inking gap behavior in the inking gap 19 and the inking gap 18.

The control device can use different parameters for the comparison between the present measurements during the adjustment of the printing gap 18 and the measurements obtained during the adjustment of the inking gap. For example, it can check at what sub-sections 26 of the surface detail 25 of the format cylinder certain light intensity values are exceeded or fallen short of. If it results here that during the present measurements a certain portion of the sub-sections 26 of a surface detail 25 shows significant changes in intensity I of the remitted light and this portion is equivalent to the respective portion of a measurement during the adjustment of the inking gap, the control device can operated in the above-described fashion and determined the additional adjustment value D.

Additionally or supplementary here the control device may also check in what way sub-sections 26 of a surface detail 25 are aligned in reference to each other and in case of identical allocation patterns it can assume a measurement in similar relative positions of the surfaces.

FIG. 2 illustrates once more the progression between the adjustment of the inking gap 19 and the printing gap 18, because FIGS. 2 and 3 show the same time frame. The contacting of the roller package comprising the anilox roll 5 and the format cylinder 6 against the impression cylinder 9 begins at the point of time t4, at which the optimized roller distance B between the format cylinder and the anilox roll is already known to the control device. Initially a distance is adjusted in which already a partial contact can be expected between the format cylinder 6 and the impression cylinder 9. Here, measurements are performed yielding a measuring result which shows similarities to the measuring result during the adjustment of the inking gap 19. The additional adjustment value D is determined. Directly after the point of time t5 the additional adjustment occurs by D and the optimized distance C is adjusted between the format cylinder and the impression cylinder.

List of reference characters

| | |
|---|---|
| 1 | Inking unit |
| 2 | Ink |
| 3 | Ink reservoir doctor |
| 4 | Ink coating |
| 5 | Anilox roll |
| 6 | Format cylinder |
| 7 | First block |
| 8 | Second block |
| 9 | Impression cylinder |
| 10 | Arrow (direction of rotation of the anilox roll) |
| 11 | Arrow (direction of rotation of the format cylinder) |
| 12 | Arrow (direction of rotation of the impression cylinder) |
| 13 | Inkless surface of the anilox roll |
| 14 | Direction of ink transportation |
| 15 | First optic sensor |
| 16 | Second optic sensor |
| 17 | Doctor blade |
| 18 | Second roller gap/printing gap |
| 19 | First roller gap/inking gap |
| 20 | Run up |
| 21 | Run up section when approaching the cylinder 5, 6 |
| 22 | Run up section when the cylinder 5, 6 is stationary |
| 23 | Detailed elevation profile |
| 24 | Simplified elevation profile |
| 25 | Surface detail of the format cylinder 6 |
| 26 | Sub-section of the surface detail 25 of the format cylinder 5 |
| 27 | |
| 28 | |
| 29 | |
| 30 | |
| 31 | |
| 32 | |
| 33 | |
| 34 | |
| A-A | Line |
| B | Optimized distance anilox roll/format cylinder |
| C | Optimized distance format cylinder/impression cylinder |
| D | Additional adjustment value (reduction or increase of the |
| | distance x between the impression cylinder and the format |
| | cylinder |
| E | Correction value for the additional adjustment value |
| t1 to t5 | Points of time during the contacting of cylinders |
| S | Target distance |

1. A method for adjusting the distances (x) between cylinders (5, 6, 9) of an inking unit (1), limiting at least two cylinder gaps (18, 9), and in which the distances (x) are adjusted based on measurements gathered from the surface of at least one of the cylinders (5, 6, 9) of the inking unit (1),
characterized in that
during the adjustment of the distance (x) between the two cylinders (5, 6, 9) limiting a second cylinder gap (18, 19) here information is used which was gathered during the adjustment of the distance between the two cylinders (5, 6, 9) limiting the first cylinder gap (18, 19).

2. A method according to claim 1,
characterized in that
the adjustment of the distance (x) of the cylinders limiting at least two cylinder gaps (18, 19) occurs based on measurements yielded from the surface of a single cylinder (5, 6, 9) of the inking unit (1).

3. A method according to claim 2,
characterized in that the measurements are yielded from the surface of one cylinder (5, 6, 9), which is located upstream in reference to at least two cylinder gaps (18, 19) in the direction of transportation of the ink (14) or which limits the first (19) of at least two cylinder gaps in the direction of transportation of the ink (14) towards the front in the direction of transportation of the ink (14).

4. A method according to claim 3, characterized in that
firstly the distance (x) is adjusted between the inking cylinder (5) and a pressure cylinder (6) and that later the distance is adjusted between the pressure cylinder (6) and an impression cylinder (9).

5. A method according to claim 2,
characterized in that
the measurements are gathered by a sensor (15, 16) monitoring the ink layer (4) on an inking cylinder (5).

6. A method according to claim 5,
characterized in that
the sensor directly monitors the ink layer (4) on the continuously rotating surface of the inking cylinder (5).

7. A method according to claim 1,
characterized in that
the sensor (15, 16) gathers measurements while the inking cylinder (5) is rotating.

8. A method according to claim 7,
characterized in that
the measurements are gathered at least during a portion of the period in which the inking cylinder (5) performs an uninterrupted rotation by more than 90°, advantageously by more than 180°, preferably by more than 360° about its primary axis of symmetry.

9. A method according to claim 1,
characterized in that
the adjustment of the distance between the two cylinders (5, 6, 9) limiting the second roller gap (18) occurs based on values underlying the adjustment of the distance between the two cylinders limiting the first roller gap (19).

10. A method according to claim 1,
characterized in that
after the adjustment has been performed of the distance (x) between the two cylinders (6, 9) limiting the second roller gap based on values, which were underlying the adjustment of the distance between the two cylinders (5, 6),
additional measurements are yielded on the surface of one cylinder (5), which are used to optimize the distance between the two cylinders limiting the second cylinder gap.

11. A method according to claim 10,
characterized in that
the adjustment of the distances (x) of the rollers (5, 6, 9) limiting at least two cylinder gaps (18, 19) are made based on measurements,
which are performed during or after a number of rotations, which amounts to N for the adjustment of the distance of the rollers limiting the first cylinder gap (19),
and which amounts to M for the adjustment of the distance of the rollers M limiting the second cylinder gap (18),
with M being greater than N.

12. A method according to claim 1,
characterized in that
the adjustment of the distances of the cylinders, limiting at least one of the two cylinder gaps (18, 19), is performed based on at least two measurements, which are performed at different distances (x) of the two respective cylinders (5, 6, 9).

13. A printing machine with at least one inking unit (1),
which comprises at least three cylinders (5, 6, 9), which can be made to contact each other, limiting at least two cylinder gaps (18, 19),
with the first cylinder, in the direction of ink transportation (14), being allocated to a first sensor (15), which in an operating position is mounted in the inking unit (1) of the first cylinder (5) in the direction of ink transportation (14),
characterized in
that a control device is provided designed such that based on measurements of the sensor the distances of cylinders (5, 6, 9) of the inking unit (1) can be adjusted, limiting at least two cylinder gaps (18, 19),
and that the control device is designed in order to adjust the distances (x) between the cylinders (6, 9) of the inking unit forming the second roller gap, based on knowledge gathered during the adjustment of the first roller gap (19).

14. A printing machine according to claim 13,
characterized in that
at least two printing gaps (18, 19) are limited by the same die plate cylinder (6).

15. A printing machine according to claim 1,
characterized in that
inking unit blocks are allocated to at least a portion of the cylinders (5, 6, 9) limiting at least two cylinder gaps, on which the respective cylinders (5, 6, 9) are supported at least partially and by which the position of the cylinder (5, 6, 9) in the inking unit can be displaced.
